(19) United States
(12) Patent Application Publication
(10) Pub. No.: US 2015/0089050 A1
(43) Pub. Date: Mar. 26, 2015

(54) MOBILE NETWORK SYSTEM

(71) Applicant: HITACHI, LTD., Tokyo (JP)

(72) Inventors: Seiya KUDO, Tokyo (JP); Masaki KANAZAWA, Yokohama (JP)

(21) Appl. No.: 14/327,677

(22) Filed: Jul. 10, 2014

(30) Foreign Application Priority Data
Sep. 26, 2013 (JP) 2013-199142

(51) Int. Cl. H04L 12/26

(52) U.S. Cl. CPC H04L 43/10
USPC 709/224

(57) ABSTRACT

A communication caused by applications that cannot be managed by an operator is operated on a mobile network, and is difficult to control. Therefore, burst traffic induced by the applications needs to be effectively detected, restricted, and controlled. A system has a terminal that monitors an update status of applications on a mobile network, periodically monitors the update status of the applications, extracts traffic of the applications from packets transmitted through the mobile network, summarized a traffic volume induced by the applications to detect the burst traffic generated when any application is updated, and controls the traffic of the applications when the burst is generated.

### CROSS-REFERENCE TO RELATED APPLICATION

This application claims priority from Japanese Patent Application No. 2013-199142, filed Sep. 26, 2013, which is incorporated herein by reference in its entirety.

### BACKGROUND OF THE INVENTION

1. Field of the Invention

The present invention relates to a mobile network system, and more particularly to a technique for detecting and controlling burst traffic generated on a network.

2. Description of Related Art

As a method of controlling traffic on the network, there are a load balancing technique and a shaping technique. In those techniques, in general, users having a given throughput or higher are suppressed without any exception, or users using specific applications are restricted. In those techniques, there is a need to specify the users or the applications in advance, and unknown applications are difficult to restrict.

For example, JP-A-2012-23629 discloses a technique in which the traffic is sampled to extract high-rate traffic. Also, JP-A-2012-109905 discloses a system for capturing, analyzing, and controlling packets in real time. However, there is no disclosure to identify extraordinary traffic, and grounds for determination as extraordinary are ambiguous.

With the rapidly increasing of smartphones, most of applications used in the smartphones and tablet terminals are different from traditional applications of network services particular to mobile operators which are distributed on a mobile network, which are controlled by the operator. For that reason, a communication caused by the application that cannot be controlled by the operator is travelled on the mobile network. The operator cannot control the above traffic, and may generate burst traffic on the network. The burst traffic induced by those applications has the potential to burden the overall mobile network, and induce a severe system failure. The operator sees that the burst traffic is restricted and controlled as an issue.

On the other hand, it is difficult for the operator to grasp the behaviors of all applications, and updating schedules. If packets can be captured from all of equipments on the network, and the transmitting packets can be analyzed, all of the applications used in the world can be classified and controlled. However, such a system becomes very low in cost-benefit performance. The applications really having the potential to affect the network are a part of all the applications, and how to extract and control those applications is an issue.

In this way, in order to control the burst traffic caused by the applications, when to control any application is an issue. If an equipment for suppressing and controlling the burst is placed in each of the equipments or between the respective equipments, and always monitors all of the applications, the burst traffic can be controlled. However, this system becomes low in the cost-benefit performance. Under the circumstances, how to detect the applications to be controlled, and how to control as occasion demands become critical.

### SUMMARY OF THE INVENTION

In order to solve the problem, according to an aspect of the invention, a mobile network system includes a terminal that monitors an update status of an application used in a mobile network, a base station, and an analysis server that analyzes traffic induced by the application, in which the terminal includes a first management unit that manages information on an update application for updating, and a transmission unit that transmits the information on the update application to the analysis server, and the analysis server includes a second management unit that manages the number of accesses to the update application, a determination unit that determines whether the traffic induced by the update application is burst traffic, or not, on the basis of the number of accesses to the update application, and a control unit that issues a warning so as to control the traffic induced by the update application which is determined to be the burst traffic.

According to the invention, the burst traffic induced by the application can be efficiently controlled.

### BRIEF DESCRIPTION OF THE DRAWINGS

FIG. 1 is a sequence diagram illustrating a process of updating application by a wireless terminal;

FIG. 2 is a system configuration example in this embodiment;

FIG. 3 is a block diagram illustrating a configuration of an application update confirmation terminal;

FIG. 4 is a diagram illustrating an example of an application management table;

FIG. 5 is a diagram illustrating an example of an update application management table;

FIG. 6 is a block diagram illustrating a configuration of a DPI equipment;

FIG. 7 is a diagram illustrating a packet format example of a call processing signal packet;

FIG. 8 is a diagram illustrating a packet format example of a user data packet;

FIG. 9 is a diagram illustrating an example of an application table;

FIG. 10 is a diagram illustrating an example of a DPI log;

FIG. 11 is a block diagram illustrating a configuration of an analysis server;

FIG. 12 is a diagram illustrating an update application management table example;

FIG. 13 is a diagram illustrating a normal application management table example;

FIG. 14 is a flowchart for determining burst;

FIG. 15 is a flowchart for determining the burst;

FIG. 16 is a flowchart for determining the burst;

FIG. 17 is a flowchart for determining the burst; and

FIG. 18 is a flowchart for determining the burst.

### DESCRIPTION OF EMBODIMENTS

FIG. 2 is a diagram illustrating a configuration example of a system that detects and controls a burst traffic. A wireless terminal 101 represents a terminal used by a user which really gets a service on a mobile network. When the wireless terminal 101 gets the service with the use of an application, the wireless terminal 101 is connected to a call processing control equipment 202 through a base station 201 for the purpose of establishing a session that transmits and receives user data. The base station 201 is configured to switch between a wireless communication and a wire communication, and wirelessly communicate with the wireless terminal 101. The call processing control equipment 202 is configured to authenticate with the wireless terminal 101, and establish a session for transmitting and receiving user data. After establishing the session that transmits and receives the user data, the user data is transmitted and received. A user data control equipment 203 is connected between an internet 204 and the mobile network. The user data control equipment 203 converts packets for the mobile network into packets for the internet. A tapping equipment 205 is configured to copy the packets transmitted on the mobile network, and transfer the copy of the packets to a deep packet inspection (DPI) equipment 207. The DPI equipment 207 is configured to associate the packets of a call processing signal with the packets of the user data, which are transmitted on the mobile network, to calculate statistics such as a throughput of the user. An analysis server 208 is configured to analyze the DPI logs associated by the DPI equipment 207, and optimally control the traffic volume of the mobile network. On the basis of a result analyzed by the analysis server 208, the base station 201, the call processing control equipment 202, the user data control equipment 203, and a traffic control equipment 209 control traffic, and optimize the network. The traffic control equipment 209 is configured to control so as to instantaneously interrupt or delay the packets transmitted on the mobile network

Also, an application update confirmation terminal 206 in this embodiment has functions similar to those of the wireless terminal 101, that is, functions of collecting update information on the applications used in the wireless terminal 101, and evaluating validity of the result really controlled by the analysis server. An application provision server 102 connected to the internet 204 is configured to store the applications used in the wireless terminal 101, and an application/ID management server 103 is configured to manage version information on the applications and the number of users using the application. The application provision server 102 and the application/ID management server 103 can operate as the same server.

A lot of applications used by the users are installed in the wireless terminal 101. The applications may be updated in the version managed as a function addition or fixing problems of the application. It is conceivable that the applications installed in the wireless terminal 101 are updated normally in two methods. In one method, the user autonomously updates the applications. In the other method, the server that manages the applications notifies the wireless terminal 101 of the update of the applications, and thereafter the applications autonomously update themselves, or the user autonomously updates the applications in the same manner as that of the one method.

In the system illustrated in FIG. 2, the update of the applications is monitored by the application update confirmation terminal 206 implemented in the base station 201, and when any application is updated, traffic caused by update of that application is monitored by the application update confirmation terminal 206. The application update confirmation terminal 206 can be provided as an internal function of the base station 201, or provided as another equipment different from the base station 201 as with a normal terminal.

The application update confirmation terminal 206 not only manages and monitors the updated application, but also can execute the update of the application at every given time interval, for example, every one hour, and grasp a state of the network when updating the application, for example, an influence of the application on the network by summarizing a communication time from an application update start to an application update end, or the number of transmit or receive packets. Also, if the application is to be controlled by the traffic control equipment 209, the restricting operation of the application can be confirmed by the above-mentioned periodic update.

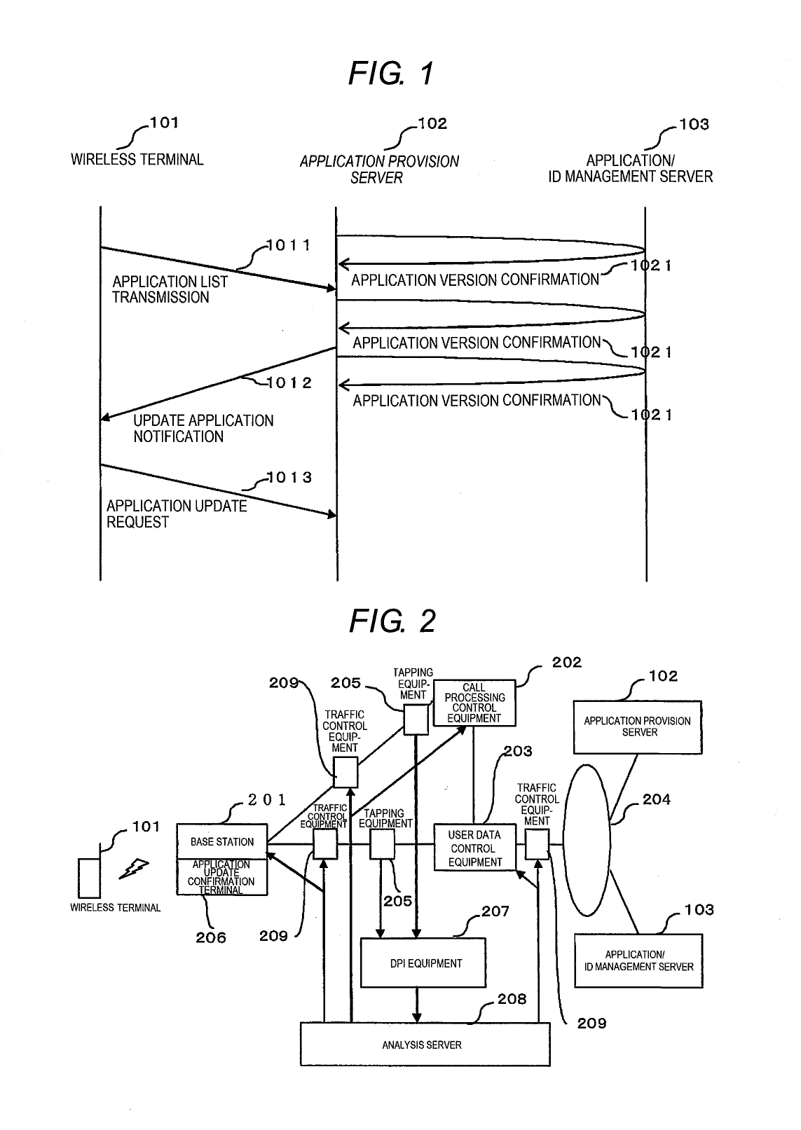

FIG. 1 is a sequence diagram illustrating a process of updating the application by the wireless terminal 101. When the normal application is updated, the terminal confirms the version of the application currently used with the application provision server. The version confirmation by the terminal is operated on the application management list managed within the terminal at the same time, or operated on only the individual applications. Also, the application/ID management server 103 may notify the terminal to the latest version without operating of terminal.

Referring to FIG. 1, when the wireless terminal 101 updates the application, the wireless terminal 101 transmits an application list (1011) possessed by the wireless terminal 101 to the application provision server 102. The application provision server 102 periodically confirms the version information on the update application from the application/ID management server 103, and manages the version information. The application provision server 102 and the application/ID management server 103 are described as separate servers, but can be managed and implemented in the same server. The application provision server 102 that receives the application list from the wireless terminal 101 confirms whether the application whose version is updated exists within the application list transmitted from the wireless terminal 101, or not, on the basis of the application version information confirmed with the application/ID management server 103. If the updated application exists, the application provision server 102 notifies the wireless terminal 101 of the updated application as well as its version (1012). The wireless terminal 101 that has confirmed the update of the application transmits an application update request (1013) to the application provision server 102 by user autonomously or application autonomously, and updates the application.

The example of the system illustrated in FIG. 2 represents a system that captures the list of the applications managed by the application provision server 102 and the application update request (1013), to thereby detect and control signaling burst caused by update of the application.

A communication between the wireless terminal 101 and the application provision server 102 is started by connecting on the call processing control equipment 202 for the purpose of establishing a session. After the session is established, a sequence of updating the application list illustrated in FIG. 1 is processed. The update sequence of the application is processed through the wireless terminal 101, the base station 201, the user data control equipment 203, and the internet 204 in the stated order.

Because the update status of the application is managed by the application provision server 102 and the application/ID management server 103, it is difficult for the equipment of the mobile network and the operator to grasp the update status of the application. Under the circumstance, the application update confirmation terminal 206 is implemented a function of periodically confirming the update status of the applications. The application update confirmation terminal 206 is equivalent to the normal wireless terminal 101, and the same terminal as the wireless terminal 101 is implemented, or the same function as the wireless terminal 101 is provided in the base station 201.

As with a case in which the wireless terminal 101 updates the application, the application update confirmation terminal 206 gets and manages the information on the update application according to the sequence illustrated in FIG. 1. The updated application update information is periodically transferred to the analysis server 208. The analysis server 208 analyzes and controls traffic related to the application from the real packet on the basis of the application update information. If there is a difference in the application update information transmitted from the application update confirmation terminal 206, the analysis server 208 notifies (warns) the traffic control equipment 209, the base station 201, the call processing control equipment 202, and the user data control equipment 203 of the update information on the application. The respective equipments that have received the warning monitor a communication caused by the application until the respective equipments receive a burst generation alarm, or the warning is canceled.

On the other hand, the packets transmitted on the mobile network are copied by the tapping equipment 205, and transferred to the DPI equipment 207. Call processing information for establishing the session is included in data (call processing signal packet) between the base station 201 and the call processing control equipment 202, and the user information is included in the packets. Also, data (user data packet) between the base station 201 and the user data control equipment 203 includes information on the used service or application in the communication between the application servers in real. The tapping equipment 205 transfers a copy of those packets to the DPI equipment 207, and the DPI equipment 207 analyzes which application is actually used by the user for communication.

After the DPI equipment 207 has identified the application used by the user, the analysis server 208 determines whether the traffic is induced by the updated application, the traffic generates the burst by further updating the application, or the burst is generated regardless of the update of the application. The analysis server 208 transmits a notice (alarm) that the burst is generated by the application determined by the analysis server 208 to generate the burst to the traffic control equipment 209, the base station 201, the call processing control equipment 202, and the user data control equipment 203. The respective equipments that have received the alarm control to restrict a communication of the application. After the alarm has been generated, the communication of the application is continued to be controlled until a notice of cancel is operated by the analysis server 208.

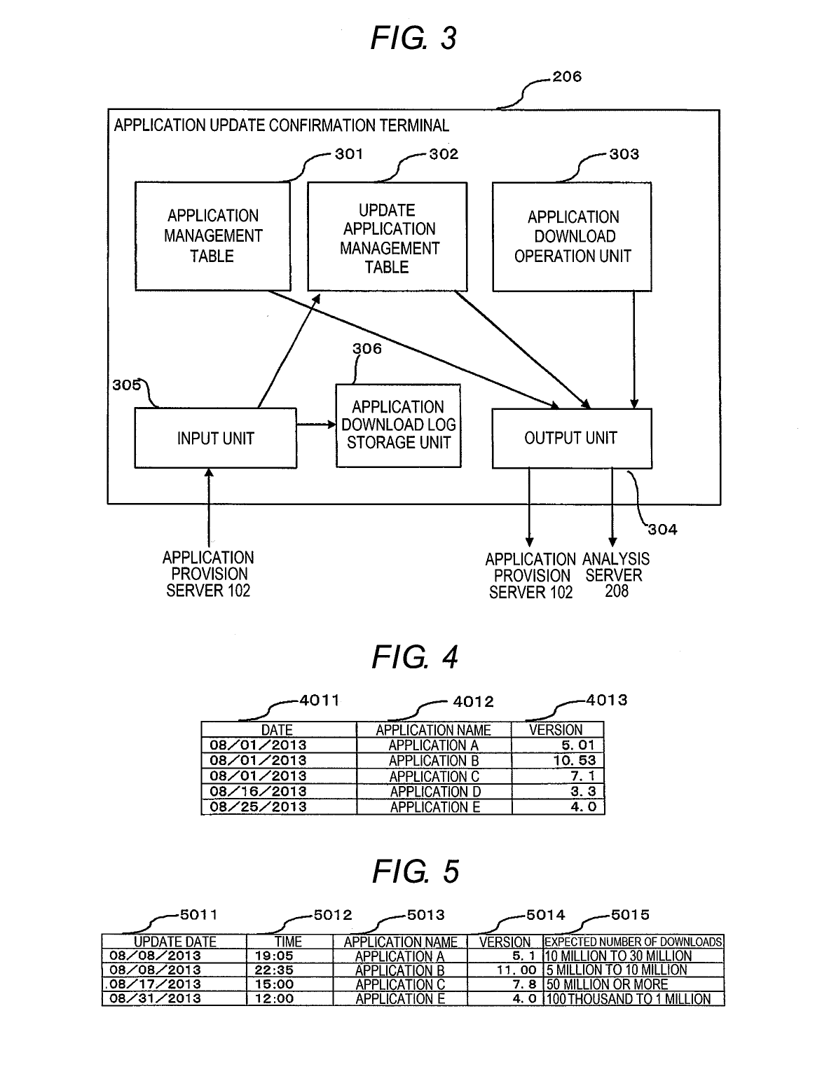

FIG. 3 is a block diagram illustrating a configuration of the application update confirmation terminal 206. The application update confirmation terminal 206 is implemented with an application management table 301 and an update application management table 302. Also, the application update confirmation terminal 206 is implemented with an application download operation unit 303 for confirming the operation of an application to be updated, and an application download log storage unit 306 for storing an execution log when the application to be updated is downloaded.

The application management table 301 is a list of the applications to be managed by the mobile operator. The application management table 301 is a part of an application table 6022 managed by the DPI equipment 207, and can be arbitrarily created by the mobile operator. Also, a normal application management table 11032 generated by the result of the analysis server 208 can be used.

The applications shown in the application management table 301 is not installed in the application update confirmation terminal 206, and the applications cannot be actually used, but a pseudo state in which the applications are installed is provided. That is, information such as the application names and the version information necessary for update is managed. When the application has been actually updated, the download of the applications is executed by the application download operation unit 303 periodically, for example, at every one-hour in order to confirm the operation of the application. After the execution, the downloaded files are deleted, and information on a download time or the number of packets is stored in the application download log storage unit 306.

FIG. 4 is a diagram illustrating an example of application management table 301. The application management table 301 includes a date 4011 of the application registration, an application name 4012, and a version 4013 of the applications. The update application management table 302 is created by comparison with a response of the application provision server 102 on the basis of the above information.

The application update confirmation terminal 206 periodically transmits the application management table 301 to the application provision server 102 through an output unit 304. If the updated application is present among the applications shown in the received application management table 301, the application provision server 102 transmits only the updated application to the application update confirmation terminal 206. The application list transmitted from the application provision server 102 is stored in the update application management table 302 through an input unit 305 of the application update confirmation terminal 206.

The update application management table 302 is transferred to the analysis server 208 through the output unit 304 periodically, for example, at every 10-seconds or 1 minute.

FIG. 5 is a diagram illustrating an example of the update application management table 302. The update application management table 302 includes an update date 5011, an updated application information reception time 5012, an application name 5013, a version 5014, and an expected number of downloads 5015. It is assumed that the number of users using the application under consideration is considered as the expected number of downloads 5015. The expected number of downloads 5015 is managed by counting the number of users downloaded by the application provision server 102. The update application management table 302 gets the above information from the application provision server 102. In fact, the number of users downloaded is not an actual number but, for example, given by an approximate number such as 10 million people or more. For that reason, the expected number of downloads is determined according to the above number and a number of a subsequent range.

If the update of the application is found by the application update confirmation terminal 206, there is a need to detect the application. The application is detected by the DPI equipment 207.

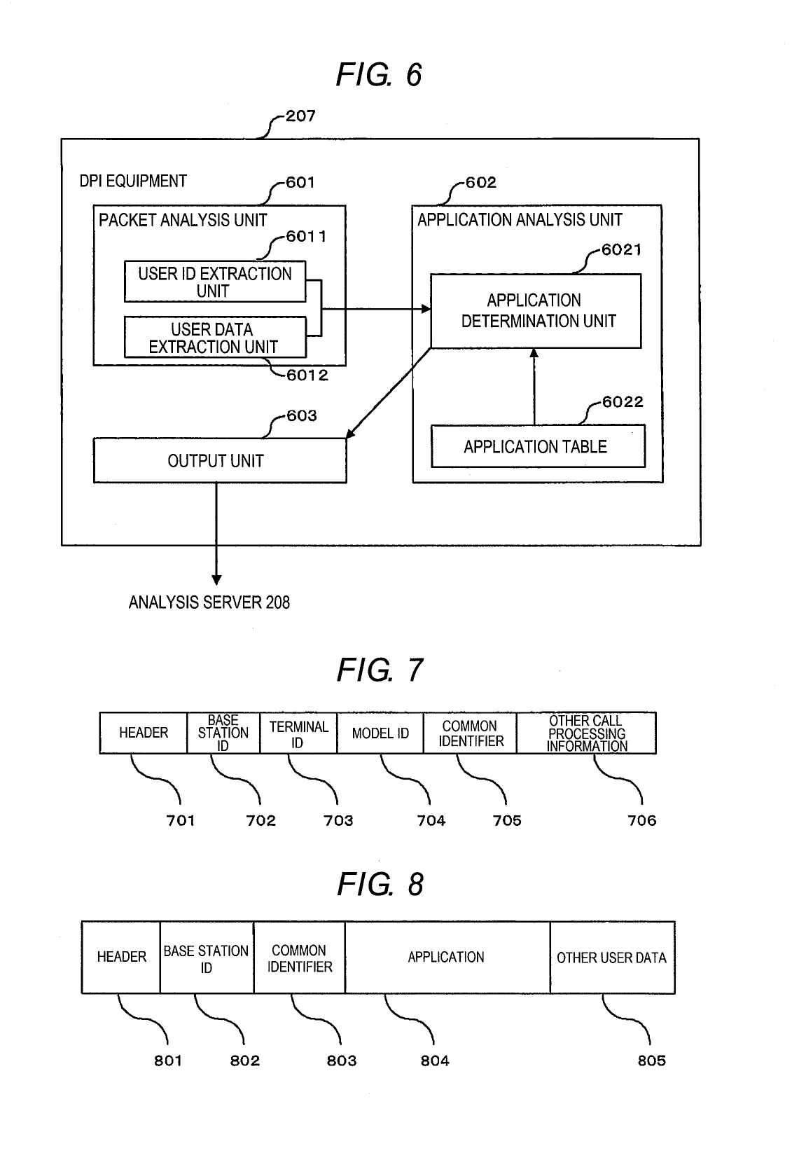

FIG. 6 is a block diagram illustrating a configuration of the DPI equipment 207. The DPI equipment 207 includes a packet analysis unit 601, an application analysis unit 602, and an output unit 603. The packet analysis unit 601 extracts information on the user ID from the call processing signal packets between the base station 201 and the call processing control equipment 202 by a user ID extraction unit 6011 on the basis of the call processing signal packets between the base station 201 and the call processing control equipment 202 and the user data packets between the base station 201 and the user data control equipment 203, which are copied by the tapping equipment 205. The packet analysis unit 601 extracts the information on the used application from the user data packets between the base station 201 and the user data control equipment 203 by a user data extraction unit 6012, and associates the extracted information with each other by identifiers that associate the packets of the respective information with each other.

A packet format example of the call processing signal packets transferred from between the base station 201 and the call processing control equipment 202 to the DPI equipment 207 is illustrated in FIG. 7. A packet format example of the user data packets transferred from between the base station 201 and the user data control equipment 203 to the DPI equipment 207 is illustrated in FIG. 8. The DPI equipment 207 extracts base station IDs 702, 802, a terminal ID 703, a model ID 704, common identifiers 705, 803, and information 804 related to the application from the packets shown in FIG. 7 and FIG. 8. It is general that the common identifiers 705 and 803 use an IP address and a tunnel ID of the base station 201. The DPI equipment 207 associates the call processing signal packets with the user data packets to grasp an influence on the call processing signal when the update of the application is executed.

An application determination unit 6021 implemented in the application analysis unit 602 determines how the service/application of the packets in the associated information is on the basis of the application information stored in the application table 6022.

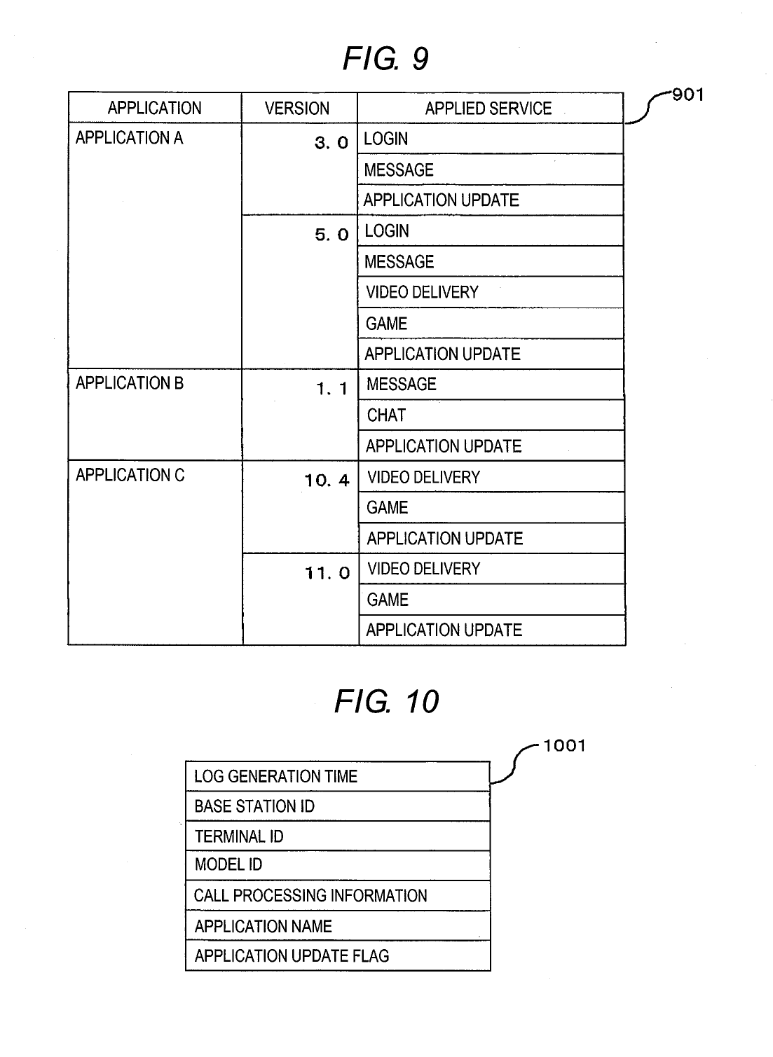

FIG. 9 is a diagram illustrating an example of the application table 6022. The application table 6022 includes the application name, the version information as well as a service provided by using the application under consideration. The data extracted by the DPI equipment 207 is compared with the application table 6022 to grasp what kind of service is provided by any application. In this embodiment, it is determined whether the user data packets correspond to the application update service disclosed in the application table 6022, or not. If the user data packets correspond to the application update service, an application update flag is set. For example, if it is determined that the user data packets are packets related to the application update service with reference to the information 804 related to the application included in the user data packet received by the DPI equipment 207, an application update flag is set in the DPI log. The determination result is transferred to the analysis server 208 through the output unit 603 as the DPI log. The DPI log transferred from the DPI equipment 207 to the analysis server 208 is generated with a series of sessions generated according to the service of the application as one DPI log. The sessions are generated by a lot of packets transmitted and received between the wireless terminal 101 and the base station 201, and the base station 201 and the call processing control equipment 202 or the user data control equipment 203, and the DPI log is generated on the basis of the sessions. The sessions are different depending on the mobile network system, and the DPI log generated for each of the mobile network systems is different from each other.

FIG. 10 is a diagram illustrating an example of the DPI log transferred from the DPI equipment 207 to the analysis server 208. The DPI log includes a log generation time, the base station ID, the terminal ID, the model ID, the call processing information, the application name, and the application update flag. The analysis server 208 that has receives the DPI log can determine whether the DPI log relates to the update application, or not, with reference to the application update flag.

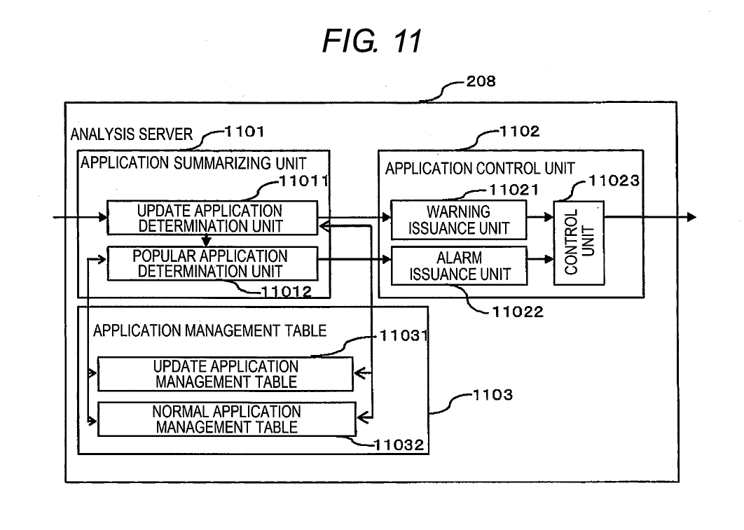

FIG. 11 is a block diagram illustrating a configuration of the analysis server 208. The analysis server 208 includes an application summarizing unit 1101, an application control unit 1102, and an application management table 1103.

The analysis server 208 receives information of the update application management table 302 from the application update confirmation terminal 206. The received update application information represents a list of the applications updated within a given time, for example, within one day, one hour, or 10 minutes. The analysis server 208 that has gotten the information stores the information in an update application management table 11031 of the application management table 1103 implemented within the analysis server 208. The information is recognized as a remarkable application by a warning issuance unit 11021 of the application control unit 1102. A control unit 11023 notifies the base station 201, the call processing control equipment 202, the user data control equipment 203, and the traffic control equipment 209 that the application has been updated.

The base station 201, the call processing control equipment 202, the user data control equipment 203, and the traffic control equipment 209 which have received an application update notification monitor the application until an alarm (burst generation alarm) is issued and notified from the analysis server 208, or a warning cancel notification is notified. When a rapid change in the traffic volume is generated in a monitoring state, the traffic control equipment 209 interrupts a communication associated with the application.

The analysis server 208 analyzes the real traffic on the basis of the update application information transmitted from the application update confirmation terminal 206. The analysis server 208 determines whether the information on the application included in the DPI log transferred from the DPI equipment 207 is included in the update application management table 11031 in an update application determination unit 11011 within the application summarizing unit 1101, or not.

The DPI logs transferred from the DPI equipment 207 have two patterns. There is a DPI log corresponding to the update application, and a DPI log corresponding to applications other than the update application. The number of accesses is counted by the analysis server every time the DPI logs are transferred from the DPI equipment 207 to the analysis server 208. That is, the number of DPI logs of the update application corresponds to the number of users who update the application. Also, the number of DPI logs becomes the number of accesses to the application. Likewise, the number of DPI logs of the applications other than the update application corresponds to the number of users who get the service by the application, and becomes the number of accesses to the application. A total of the number of accesses to the update application and the number of accesses to the applications other than the update application is a total number of accesses to the application in the system.

The total number of accesses included in the data, the number of accesses to the update application, and the number of accesses to the applications other than the update application are summarized every time the DPI logs are transmitted by the DPI equipment 207 (the summarizing results are stored in the update application management table 11031 and the normal application management table 11032.

When the application shown by the DPI log transferred from the DPI equipment 207 is included in the update application management table 11031, the traffic volume of the application, for example, the number of accesses, and the traffic volume of the call processing signal caused by the application, for example, the number of accesses are added per unit time, to update the update application management table 11031. In this situation, the application summarizing unit 1101 determines whether burst occurs, or not, on the basis of the information of the update application management table 11031 by a popular application determination unit 11012.

When the application shown by the DPI log transferred from the DPI equipment 207 is not included in the update application management table 11031, the update application management table 11031 is not updated, the traffic volume (for example, the number of accesses) of the application is recorded and stored in the normal application management table 11032. Then, the application summarizing unit 1101 determines that the application described in the normal application management table 11032 is burst by the popular application determination unit 11012.

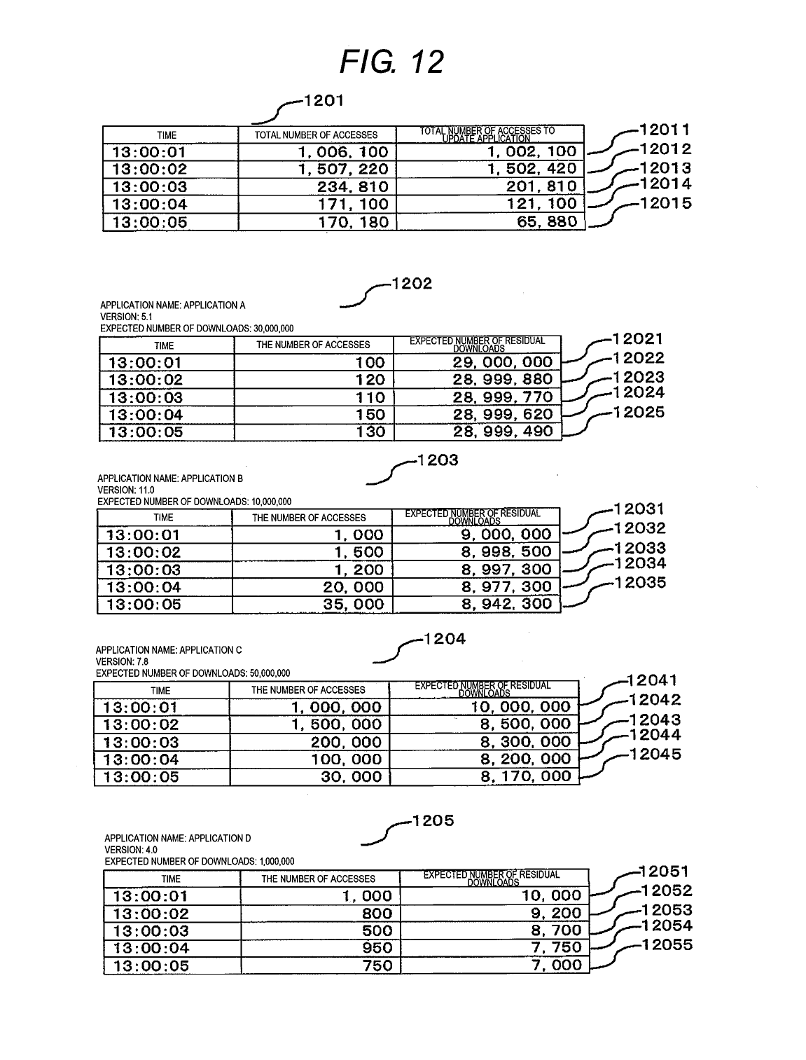

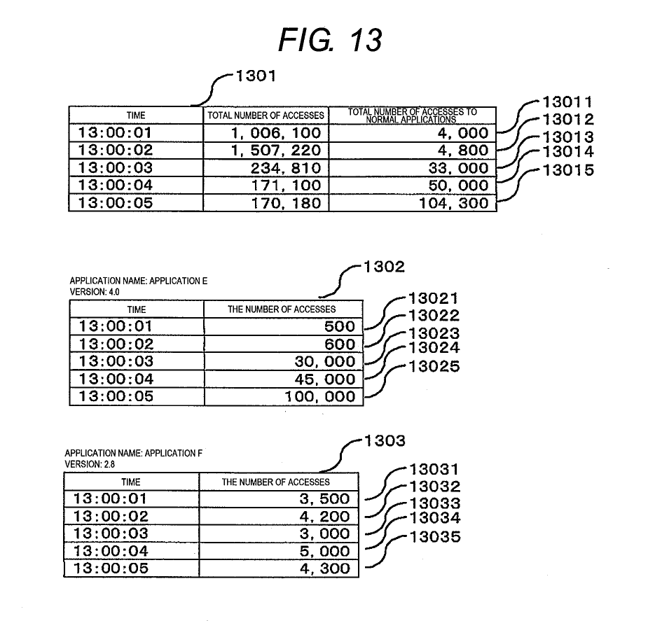

FIG. 12 illustrates an example of the update application management table 11031, and FIG. 13 illustrates an example of the normal application management table 11032.

An update application management table illustrated in FIG. 12 includes an access number management table 1201, and individual update application management tables 1202 to 1205. The access number management table 1201 includes the total number of accesses to all of the applications for the unit time of a measurement time, and the total number of accesses to the updated application. This example shows the total number of accesses to all of the applications for five seconds from 13:00:00 to 13:00:05, and the total number of accesses 12011 to 12015 to the updated application.

The individual update application management tables 1202 to 1205 are generated for every application on the basis of the information of the update application list transferred from the application update confirmation terminal 206. The table includes an application name, a version, an expected number of downloads, the number of accesses per unit time, and an expected number of residual downloads which is expected after that time. The application name, the version, and the expected number of downloads are generated on the basis of the information of the update application list transferred from the application update confirmation terminal 206. The expected number of downloads is recorded in a range as illustrated in FIG. 5, and an upper limit value is defined as the expected number of downloads. However, if the upper limit value is not defined, its lower limit value is assumed as the expected number of downloads in a range (a case only written as 50 million or more) in which a frequency distribution is largest. In an example of FIG. 5, the respective expected numbers of downloads of applications A, B, C, and D are 30 million, 10 million, 50 million, and 1 million.

The number of accesses is calculated by extracting the traffic related to the application under consideration from the traffic actually transmitted on the mobile network by the DPI equipment 207. The expected number of residual downloads represents a value resulting from subtracting the number of accesses at the time from the expected number of downloads.

The popular application determination unit 11012 of the analysis server 208 determines the burst traffic on the basis of the individual update application management tables 1202 to 1205. In the determination of the burst traffic, a case in which any one of the following three conditions is satisfied is determined as the burst traffic.

Condition (1): A measurement result at one measurement time is compared with a measurement result (the number of accesses) at a previous time, and become α times (α>1) or more of the measurement result at the previous time.

Condition (2): The total number of accesses to the update application is set as a population, and a rate of the number of accesses to the application in the population is equal to or higher than β (β<1).

Condition (3): The total number of accesses to all of the applications is set as the population, and a rate of the number of accesses to the application in the population is equal to or higher than γ (γ≦β<1).

For example, in the individual update application management tables 1202 to 1205 illustrated in FIG. 12, a case in which α=10, β=0.6, and γ=0.2 are satisfied corresponds to the burst traffic determination condition (1), and a case of 13:00:04 (12034) in the application B (1203) is determined as the burst traffic. In 1203, the number of accesses is 1,200 at 13:00:03, but the number of accesses becomes 20,000 which are about 17 times at 13:00:04.

A case of 13:00:01 (12041) to 13:00:04 (12044) in the application C (1204) corresponds to the burst traffic determination condition (2) and is determined as the burst traffic. In this situation, the total number of update access applications is 1,002,100 at 13:00:01,

1,502,420 at 13:00:02,
201,810 at 13:00:03,
121,100 at 13:00:04, and
65,880 at 13:00:05.
A rate of the number of accesses to the application C in the total number of update access application is
1,000,000/1,002,100=0.998 at 13:00:01,
1,500,000/1,502,420=0.998 at 13:00:02,
200,000/201,810=0.991 at 13:00:03,
100,000/121,100=0.826 at 13:00:04, and
30,000/65,880=0.455 at 13:00:05.
Hence, when β is 0.6, it is determined that burst is generated in the application C in an interval of 13:00:01 to 13:00:04.

A case of 13:00:05(12035) in the application B (1203) corresponds to the burst traffic determination condition (3), and is determined as the burst traffic. In this situation, the total number of accesses to the total of the update application and the normal application is 1,006,100 at 13:00:01,

1,507,220 at 13:00:02,
234,810 at 13:00:03,
171,100 at 13:00:04, and
170,180 at 13:00:05.
A rate of the number of accesses to the application B in this situation is 1,000/1,006,100=0.001 at 13:00:01,
1,500/1,507,220=0.001 at 13:00:02,
1,200/234,810=0.005 at 13:00:03,
20,000/171,100=0.117 at 13:00:04, and
35,000/170,180=0.205 at 13:00:05.
Hence, a rate of the number of accesses to the application B in the total number of accesses to all of the applications is 20.5% at 13:00:05 in 1203.

Likewise, the normal application management table 11032 illustrated in FIG. 13 includes an access number management table 1301, and individual application management tables 1302, and 1303.

The access number management table 1301 includes the total number of accesses to all of the applications, and the total number of accesses to the updated application in the unit time of the measurement time. This example shows the total number of accesses to all of the applications for 5 seconds from 13:00:00 to 13:00:05, and the number of accesses 13011 to 13015 to the applications (normal applications) not described in the update application list transmitted from the application update confirmation terminal 206.

The individual application management tables 1302 and 1303 each include the application name, the version of the application, and the number of accesses per unit time. The number of accesses is calculated by extracting the traffic related to the application from the traffic really flowing on the mobile network by the DPI equipment 207.

Likewise, the above-mentioned burst determination (conditions (1) to (3)) is applied to the individual application management tables 1302 and 1303 illustrated in FIG. 13. It is assumed that the parameters α, β, and γ are identical with those described above, that is, α=10, β=0.6, and γ=0.2. In this situation, the number of accesses exceeds α (α=10) times at a time 13:00:03 of an application E (1302) as compared with a previous time point 13:00:02 (13023), and it is determined that the burst is generated. Then, the number of accesses to the normal application is set as a population, and if any application exceeding 60% (β=0.6) within the population is present, it is determined that a communication caused by the application under consideration is burst. That is, in the normal application, “update application” described in the above-mentioned condition (2) is replaced with “normal application”, and applied. In an example of FIG. 13, it is determined that burst is generated in an application F at 13:00:01 to 13:00:02 (13031 to 13032), and it is determined that burst is generated in an application E at 13:00:03 to 13:00:05 (13033 to 13035). In the example of FIG. 13, the application E meets the above determination condition (3) at 13:00:05. However, because it has already been determined according to the above determination condition (2) that the burst is generated, it is not afresh determined according to the condition (3) that the burst is generated. The parameters α, β, and γ in this example can be arbitrarily determined.

When it is determined as the burst traffic in the popular application determination unit 11012, a burst generation alarm is issued to the application determined to generate the burst by an alarm issuance unit 11022 of the application control unit 1102. After the burst issuance alarm has been issued, a control unit 11023 notifies the base station 201, the call processing control equipment 202, the user data control equipment 203, and the traffic control equipment 209 of the burst generation alarm. The base station 201, the call processing control equipment 202, the user data control equipment 203, and the traffic control equipment 209 which have received the burst generation alarm controls to interrupt the traffic of the application, and prevents a network failure.

The burst generation alarm of the update application is canceled when any one of the following two conditions is satisfied.

Condition (1): The number of accesses to the update application is set as a population, and a rate of the application in the population is lower than β (β<1).

Condition (2): The number of accesses to all of the applications is set as the population, and a rate of the application in the population is lower than γ (γ≦β<1).

In the example illustrated in FIG. 12, since the number of accesses to the application C to the number of accesses to all of the applications becomes about 18% at 13:00:05(12045) in the application C, the burst generation alarm of the application at that time is canceled. Also, in FIG. 13, since the number of accesses to the applications to the number of accesses to the application other than the application to be updated becomes about 10% at 13:00:03 (13034) in the application F, the burst generation alarm of the application to be updated at that time is canceled. In the normal application, the “update application” in the above condition (1) is replaced with “normal application”, and applied.

When the burst generation alarm is canceled by the popular application determination unit 11012, the alarm issuance unit 11022 issues a burst generation alarm cancellation, and the control unit 11023 notifies the base station 201, the call processing control equipment 202, the user data control equipment 203, and the traffic control equipment 209 of the burst generation alarm cancellation. In this situation, when the application is to be updated, the base station 201, the call processing control equipment 202, the user data control equipment 203, and the traffic control equipment 209, which are notified of the burst generation alarm cancellation, come to a burst generation warning state, and continuously monitors the application. Also, when the application to be subjected to the burst generation alarm cancellation is not the application to be updated, the control of the application is canceled. In this situation, those equipments do not come to the burst generation warning state.

The burst generation warning is canceled when the following condition (1) is satisfied.

Condition (1): The expected number of residual downloads is lower than 1% of the expected number of downloads.

In FIG. 12, since the expected number of residual downloads becomes lower than 1% of the expected number of downloads at 13:00:02 (11052) in the application D (1105), the burst generation warning is canceled. In the update application determination unit 11011, if the above condition is satisfied, it is determined as a burst generation warning cancellation. The warning issuance unit 11021 notifies the base station 201, the call processing control equipment 202, the user data control equipment 203, and the traffic control equipment 209 of the burst generation warning cancellation to the application through the control unit 11023. In this situation, the base station 201, the call processing control equipment 202, the user data control equipment 203, and the traffic control equipment 209 cancel the burst generation warning, and cancel the monitoring of the application.

Each of the application update confirmation terminal 206, the DPI equipment 207, and the analysis server 208 described in FIGS. 3, 6, and 11 is realized by a general server equipment, and is implemented with a CPU, a memory, a hard disk, and a communication interface for communicating with another equipment although not shown. The respective functional units of the application download operation unit 303, the packet analysis unit 601, and the application summarizing unit 1101 are realized, for example, by causing the CPU to execute a program stored in the memory. Also, the application management table 301, the application table 6022, and the update application management table 11031 are realized by, for example, a hard disk or a memory.

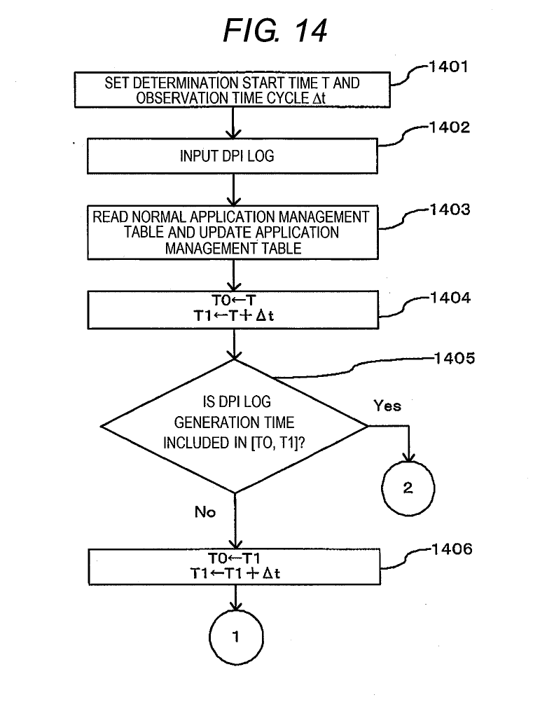

FIGS. 14 to 18 show flowcharts to determine burst traffic in the analysis server 208 according to this embodiment.

A time T at which the determination starts and an observation cycle Δt are set as an initialization (Step 1401). After the initialization, the DPI log is input as input data (Step 1402), and the normal application management table 11032 and the update application management table 11031 are read (Step 1403). Then, in order to generate a time distribution of the number of accesses of the DPI log, a duration for determination is determined. Assuming that a lower limit value of an interval range is set as T0, and an upper limit value of the interval range is set as T1, T0=T and T1=T+Δt are defined. A default of T0 is set as a time at which the determination starts (Step 1404). If the DPI log input as the input data falls within a time determined in Step 1404, the flow proceeds to a counter update flow, and if the DPI log input falls outside the interval determined in Step 1404, the flow proceeds to a management table update flow (Step 1405).

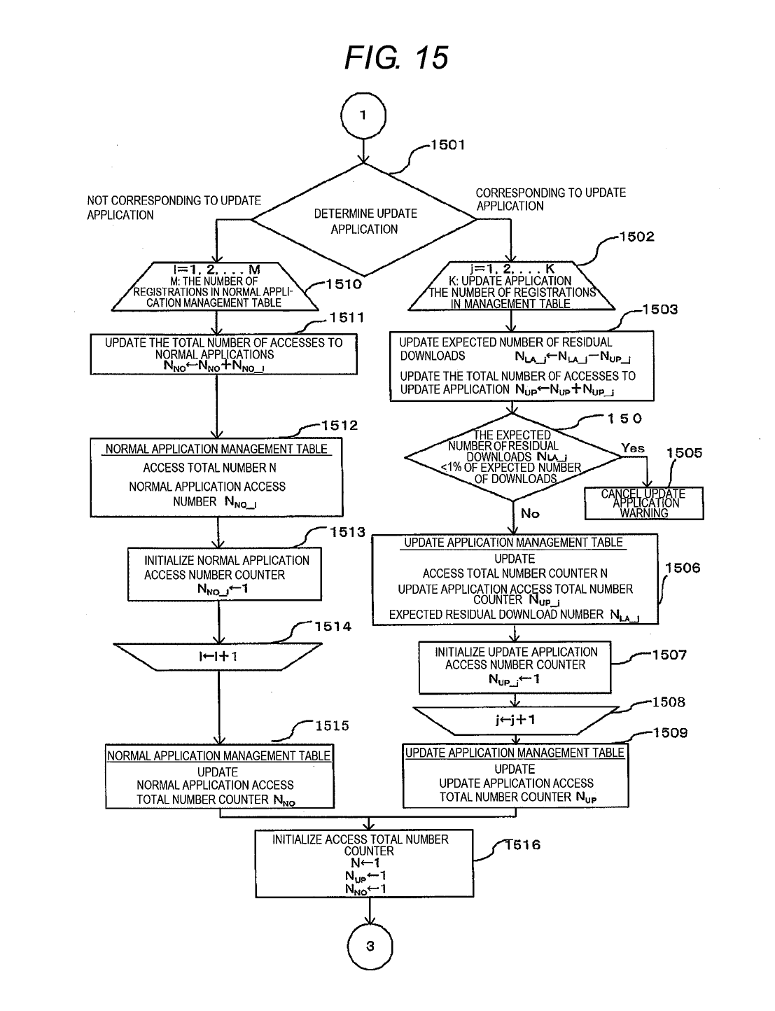

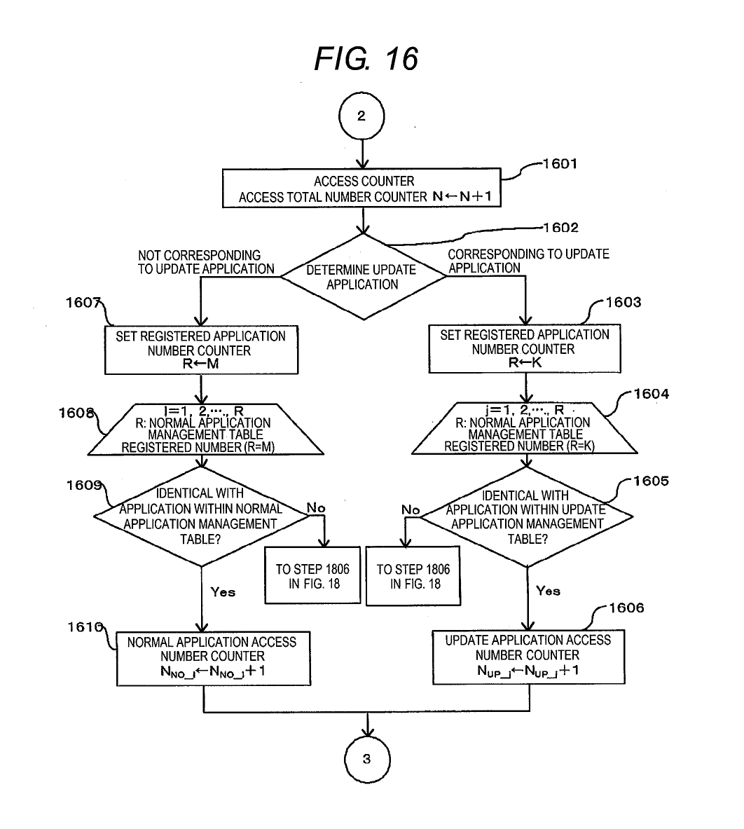

FIGS. 14 and 15 illustrate the management table update flow. FIG. 16 illustrates the counter update flow. In the management table update flow, an observation time is first updated. The upper limit value T1 in Step 1404 is set to T0, and a new upper limit value is set to T1+Δt (Step 1406). After the time is updated, it is determined whether the application is to be updated, or not (Step 1501), and if the application is to be updated, the application is processed in a flow of Steps 1502 to 1509, and if the application is not to be updated, the application is processed in a flow of Steps 1510 to 1515.

In the application to be updated, the number of accesses to the application and the expected number of residual downloads are updated for all of the applications managed in the update application management table 11031 (in this flow, k kinds of applications are managed) (Step 1502). The expected number of residual downloads is calculated by subtracting the number of accesses to the applications from the expected number of residual downloads at the previous time point (Step 1503). At the same time, an update application access total number N_{UP} in the time interval is calculated (Step 1503). In this situation, if the expected number of residual downloads is lower than 1% of the expected number of downloads, the burst warning is canceled (Steps 1504, 1505). After the completion of the warning determination, an access total number N, an update application access number N_{UP}_{_{—}}ⱼ and an expected residual download number N_{LA}_{_{—}}ⱼ of the update application management table are updated (Step 1506). After the update application management table has been updated for all of the applications to be updated, an update application access number counter is initialized (Step 1507). The processing of steps 1503 to 1507 is operated on all of the applications to be updated (Step 1508). Finally, the update application access total number N_{UP} in the update application management table is updated (Step 1509). Likewise, the normal application management table is updated, but because an item of the expected residual download number is absent in the normal application management table, this processing is not operated. If it is determined that the application is not to be updated, the number of accesses to the application is updated for all of the applications managed in the normal application management table (in this flow, M kinds of applications are managed) (1510). First, a normal application access total number N_{NO} is calculated (1511). Then, the normal application management table updates the access total number N and a normal application access number N_{NO}_{_{—}}₁ (1512). After the normal application management table has been updated for all of the applications, the update application access number counter is initialized (1513). The processing of Steps 1511 to 1513 is operated on all of the target applications (1514). After all of the normal applications have been processed, the normal application access total number N_{NO} of the normal application management table is updated (1515).

Finally, the access total number N, the update application access total number N_{UP}, and the normal application access total number N_{NO} are initialized (1516).

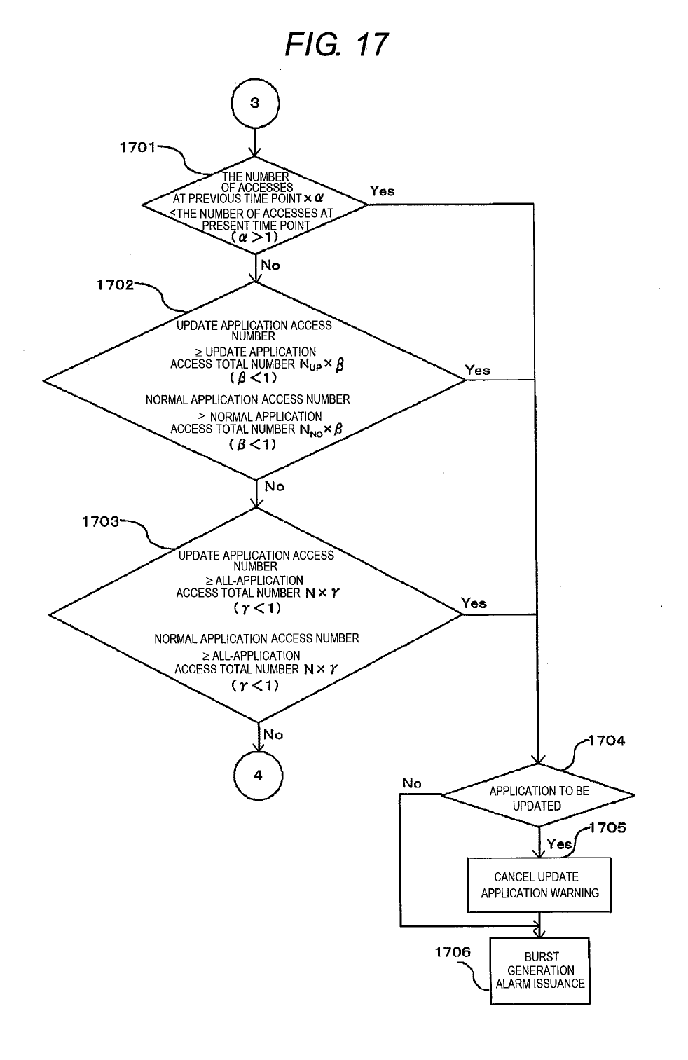

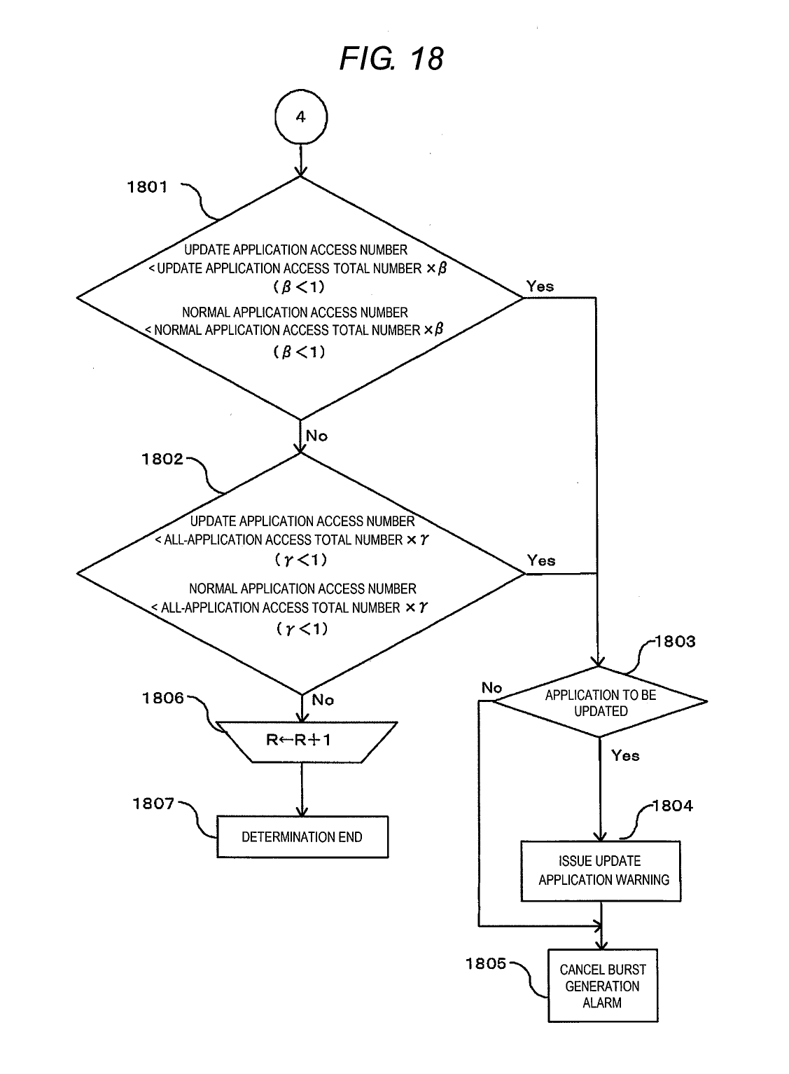

If the DPI log is included within the observation time in Step 1405 of FIG. 14, the flow proceeds to the counter update flow. In the counter update flow of FIG. 16, the access total number N is added (Step 1601). It is determined whether the application described in the DPI log is the application to be updated, or not (Step 1602). If the application is to be updated, a flow of Steps 1603 to 1606 is operated, and if the application is not to be updated, a flow of Steps 1607 to 1610 is operated. Because the burst determining process processed in FIGS. 17 and 18 is identical in both of the update application and the normal applications, the number of registered applications is stored in the same variable R (Steps 1603, 1607). In the application to be updated, it is determined whether the application to be updated is identical with any application registered in the update application management table, or not (Step 1605). If identical, the update application access number N_{UP}_{_{—}}ⱼ is added (Step 1606). If the application is not to be updated, it is determined whether the application is identical with any application registered in the normal application management table, or not (Step 1609). If identical, the normal application access number N_{NO}_{_{—}}₁ is added (Step 1610).

If any application is not identical between the update application management table and the normal application management table (no in Step 1605 or 1609), the addition of the counter and the burst determination flow are not operated, and the flow proceeds to a subsequent application (proceed to Step 1806 in FIG. 18). The processings of Steps 1602 to 1610, 1701 to 1706, and 1801 to 1806 are operated on all of the applications.

FIG. 17 shows a flowchart illustrating a process of issuing the burst generation alarm. In the determination of the burst generation alarm, the number of accesses at the previous time point is compared with the number of accesses at the present time point, and it is determined that the burst is generated in any of a case in which the number of accesses at the present time point is equal to or higher than α times (α>1) of the number of accesses at the previous time point (Step 1701), a case in which the number of accesses to the update application or the normal application is equal to or higher than a given rate β (β<1) of the sum of the numbers of accesses to the update applications or the normal applications (Step 1702), or a case in which the number of accesses (irrelevant to the presence or absence of update) to the application is equal to or higher than a given rate γ (γ<1) of the sum of the numbers of accesses to all of the applications (Step 1703). In this situation, if the application to be determined corresponds to the application to be updated, the update application warning has already been issued to the application. Under the circumstance, if the application to be determined corresponds to the application to be updated (Step 1704), the update application warning is canceled (Step 1705), and the burst generation alarm is issued (Step 1706). If the application does not correspond to the application to be updated, only the burst generation alarm is issued (Step 1706).

FIG. 18 shows a flowchart illustrating a process of canceling a state in which the burst generation alarm is issued. In the determination condition for canceling the burst generation alarm, the number of accesses to the update application or the normal applications is lower than a given rate β (β<1) of the sum of the numbers of accesses to the update application or the normal applications (Step 1801), or the number of accesses (irrelevant to the presence or absence of update) to the application is lower than a given rate γ (γ<1) of the sum of the numbers of accesses to all of the applications (1802). If any one of those conditions is met, it is determined that the application is not in the burst state. In this case, if the application to be determined corresponds to the application to be updated (S1803), the update application warning is again issued (S1804), and the burst generation alarm is canceled (1805). If the application to be determined does not correspond to the application to be updated, the burst generation alarm is canceled (Step 1805). The determination of the update application and the determination of the burst generation are operated on all of the applications registered in the update application management table and the normal application management table (Step 1806). With the above processing, the determination process is completed.

As has been described above, according to this embodiment, the packets transmitted on the network are copied and analyzed to extract only the packets related to the specific application or the communication from the specific server, and accumulate its frequency. If the frequency exceeds a given number, the alarm is issued, and a control of restricting the application or the traffic from the server can be operated.

According to the present invention, the burst traffic that is generated on the network, and has potential to severely affect the network can be deterred, and the system failure can be prevented. Also, unnecessary regulation is not effected on the users, and the communication can be supported in the best communication status on a moment-to-moment basis. Also, the application having the potential to affect the network is extracted to narrow the points on the network where the traffic is controlled.

What is claimed is:

1. A mobile network system comprising:
a terminal that monitors an update status of an application used in a mobile network;
a base station; and
an analysis server that analyzes traffic induced by the application,
wherein the terminal includes:
a first management unit that manages information on an update application for updating; and
a transmission unit that transmits the information on the update application to the analysis server, and
wherein the analysis server includes:
a second management unit that manages the number of accesses to the update application;
a determination unit that determines whether the traffic induced by the update application is burst traffic, or not, on the basis of the number of accesses to the update application; and
a control unit that issues a warning so as to control the traffic induced by the update application which is determined to be the burst traffic.

2. The mobile network system according to claim 1,
wherein the mobile network system further includes a DPI equipment, and
wherein the DPI equipment includes:
a processing unit that receives a copy of packets transmitted and received by the application, gets information on the application from the copy of packets to generate DPI logs; and
a transmission unit that transmits the DPI logs to the analysis server,
wherein the second management unit calculates the number of accesses to the update application on the basis of the DPI log related to the update application transmitted from the terminal among the DPI logs.

3. The mobile network system according to claim 2,
wherein the determination unit determines that the traffic induced by the update application is the burst traffic if the number of accesses to the update application for one unit time is equal to or larger than given several times the number of accesses to the update application for another unit time before the one unit time.

4. The mobile network system according to claim 2,
wherein the second management unit manages the number of accesses to each of a plurality of update applications, and a total number of accesses to the plurality of update applications, and
wherein the determination unit determines that the traffic induced by the update application is the burst traffic if the number of accesses to the update application for one unit time is equal to or larger than a given rate of the total number of accesses to the plurality of update applications for the one unit time.

5. The mobile network system according to claim 4,
wherein the second management unit calculates, on the basis of the DPI logs related to normal applications other than the update applications transmitted from the terminal among the DPI logs, the number of accesses to the normal application, and manages the number of accesses to each of a plurality of the normal applications, a total number of accesses to the plurality of normal applications, a total number of accesses to all of the applications including the plurality of update applications and the plurality of normal applications, and
wherein the determination unit determines that the traffic induced by the update application is the burst traffic if the number of accesses to the update application for one unit time is equal to or larger than a given rate of the total number of accesses to all of the applications for the one unit time.

6. The mobile network system according to claim 1, further comprising: a server that provides the applications,
wherein the terminal includes a processing unit that holds an application name and version information to make a pseudo state in which the application is installed, and transmits the application name and the version information to the server to inquire whether the application is the update application for updating.

7. The mobile network system according to claim 1, further comprising: a control equipment that controls the traffic transmitted and received by the base station,
wherein the control equipment delays or interrupts the traffic of the update application when the control unit issues the warning.
